(19) United States
(12) Patent Application Publication
(10) Pub. No.: US 2012/0184639 A1
(43) Pub. Date: Jul. 19, 2012

(54) METHOD FOR LOWERING EMISSIONS OF A POLYURETHANE FOAM

(75) Inventors: Peter Haas, Haan (DE); Gundolf Jacobs, Rosrath (DE); Sven Meyer-Ahrens, Leverkusen (DE)

(73) Assignee: Bayer MaterialScience AG, Leverkusen (DE)

(21) Appl. No.: 13/498,979

(22) PCT Filed: Sep. 18, 2010
(86) PCT No.: PCT/EP10/05741

§ 371 Date: Mar. 29, 2012

(30) Foreign Application Priority Data
Sep. 30, 2009 (DE) 10 2009 047 846.9

(51) Int. Cl. C08G 18/06

(52) U.S. Cl. 521/159

(57) ABSTRACT

The present invention relates to a process for the production of polyurethane foams from
A1 compounds containing isocyanate-reactive hydrogen atoms and having a molecular weight of from 400 to 15,000,
A2 optionally compounds containing isocyanate-reactive hydrogen atoms and having a molecular weight of from 62 to 399,
A3 water and/or physical foaming agents,
A4 optionally auxiliary substances and additives,
A5 compounds having at least one semicarbazide group, and
B di- or poly-isocyanates
   which yields polyurethane foams with reduced formaldehyde emission and wherein the activity of the raw material mixture is not substantially affected and wherein the mechanical properties of the resulting foam (in particular compression set and ageing behaviour under humid conditions) are not adversely affected.

It is known from the prior art that polyurethane foams can emit formaldehyde, such formaldehyde emission generally being undesirable. Such emissions are detected, for example, by measurements according to VDA 275 (flask method, 3 h 60° C.) or according to VDA 276 (emission chamber test, 65° C.). Such formaldehyde emissions can already occur in freshly produced foams and are intensified by ageing processes, in particular photooxidation.

A process for reducing formaldehyde emissions from polyurethane foams by adding polymers containing amino groups is described in EP-A 1 428 847. Thus, by adding polyvinylamines, the formaldehyde content according to VDA 275 is brought below the detection limit of 0.1 ppm. A disadvantage of such functional, in particular amino-functional, additives can be their effect on the activity of the raw material mixture. Properties such as the flow behaviour or the open-cell content are often affected thereby.

It was an object of the present invention, therefore, to develop a process for the production of polyurethane foams which yields polyurethane foams with reduced formaldehyde emission and wherein the activity of the raw material mixture is not substantially affected and wherein the mechanical properties of the resulting foam (in particular compression set and ageing behaviour under humid conditions) are not adversely affected. In a further embodiment of the invention, the resulting foams are additionally to have a low migration and emission behaviour in respect of the activators and additives used.

It has now been found, surprisingly, that the above-mentioned technical object is achieved by a production process in which compounds having at least one semicarbazide group are used.

The present invention provides a process for the production of polyurethane foams with reduced formaldehyde emission by reaction of
A1 compounds containing isocyanate-reactive hydrogen atoms and having a molecular weight of from 400 to 15,000,
A2 optionally compounds containing isocyanate-reactive hydrogen atoms and having a molecular weight of from 62 to 399,
A3 water and/or physical foaming agents,
A4 optionally auxiliary substances and additives such as
   a) catalysts,
   b) surface-active additives,
   c) pigments or flame retardants,
A5 compounds having at least one semicarbazide group with
B di- or poly-isocyanates.

The amount of component A5 according to the invention that is used, based on 100 parts by weight of components A1 to A4, is from 0.1 to 10 parts by weight, preferably from 0.2 to 5 parts by weight.

The present invention in particular provides a process for the production of polyurethane foams with reduced formaldehyde emission by reaction of

component A:
A1 from 75 to 99.5 parts by weight, preferably from 89 to 97.7 parts by weight (based on the sum of the parts by weight of components A1 to A4), of compounds containing isocyanate-reactive hydrogen atoms and having a molecular weight of from 400 to 15,000,
A2 from 0 to 10 parts by weight, preferably from 0.1 to 2 parts by weight (based on the sum of the parts by weight of components A1 to A4), of compounds containing isocyanate-reactive hydrogen atoms and having a molecular weight of from 62 to 399,
A3 from 0.5 to 25 parts by weight, preferably from 2 to 5 parts by weight (based on the sum of the parts by weight of components A1 to A4), of water and/or physical foaming agents,
A4 from 0 to 10 parts by weight, preferably from 0.2 to 4 parts by weight (based on the sum of the parts by weight of components A1 to A4), of auxiliary substances and additives such as
   a) catalysts,
   b) surface-active additives,
   c) pigments or flame retardants,
A5 from 0.1 to 10 parts by weight, preferably from 0.2 to 7.5 parts by weight (based on the sum of the parts by weight of components A1 to A4), of compounds having at least one semicarbazide group
   with
   component B:
B di- or poly-isocyanates,
   wherein the production is carried out at an index of from 50 to 250, preferably from 70 to 130, particularly preferably from 75 to 115, and
   wherein all part by weight data of components A1 to A4 in the present application have been so normalized that the sum of the parts by weight of components A1+A2+A3+A4 in the composition is 100.

It has been found that compounds having at least one semicarbazide group (component A5) surprisingly act as formaldehyde acceptors. Therefore, the invention further provides the use of compounds having at least one semicarbazide group (component A5) in polyurethane compositions or in processes for the production of polyurethane foams for reducing the formaldehyde emission.

The production of isocyanate-based foams is known per se and is described, for example, in DE-A 1 694 142, DE-A 1 694 215 and DE-A 1 720 768 as well as in Kunststoff-Handbuch Volume VII, Polyurethane, edited by Vieweg and Höchtlein, Carl Hanser Verlag Munich 1966, as well as in the new edition of that book, edited by G. Oertel, Carl Hanser Verlag Munich, Vienna 1993.

They are predominantly foams containing urethane and/or uretdione and/or urea and/or carbodiimide groups. The use according to the invention preferably takes place in the production of polyurethane and polyisocyanurate foams.

The components described in greater detail hereinbelow can be used for the production of the isocyanate-based foams.

### Component A1

Starting components according to component A1 are compounds containing at least two isocyanate-reactive hydrogen atoms and having a molecular weight of generally from 400 to 15,000. In addition to compounds containing amino groups, thio groups or carboxyl groups, these are preferably to be understood as being compounds containing hydroxyl groups, in particular from 2 to 8 hydroxyl groups, especially those having a molecular weight of from 1000 to 6000, preferably from 2000 to 6000, for example polyethers and polyesters containing at least 2, generally from 2 to 8, but preferably from 2 to 6, hydroxyl groups, as well as polycarbonates and polyester amides, as are known per se for the preparation of homogeneous and cellular polyurethanes and as are described, for example, in EP-A 0 007 502, pages 8-15. Preference is given according to the invention to polyethers containing at least two hydroxyl groups.

### Component A2

There are optionally used as component A2 compounds having at least two isocyanate-reactive hydrogen atoms and a molecular weight of from 32 to 399. Such compounds are to be understood as being compounds containing hydroxyl groups and/or amino groups and/or thiol groups and/or carboxyl groups, preferably compounds containing hydroxyl groups and/or amino groups, which serve as chain extenders or crosslinkers. Such compounds generally contain from 2 to 8, preferably from 2 to 4, isocyanate-reactive hydrogen atoms. For example, there can be used as component A2 ethanolamine, diethanolamine, triethanolamine, sorbitol and/or glycerol. Further examples of compounds according to component A2 are described in EP-A 0 007 502, pages 16-17.

### Component A3

Water and/or physical foaming agents are used as component A3. As physical foaming agents there are used, for example, carbon dioxide and/or readily volatile organic substances.

### Component A4

As component A4 there are optionally used auxiliary substances and additives such as
a) catalysts (activators),
b) surface-active additives (surfactants), such as emulsifiers and foam stabilisers, in particular those with low emission such as, for example, products of the Tegostab® LF series,
c) additives such as reaction retardants (e.g. acid-reacting substances such as hydrochloric acid or organic acid halides), cell regulators (such as, for example, paraffins or fatty alcohols or dimethylpolysiloxanes), pigments, colorings, flame retardants (such as, for example, tricresyl phosphate), stabilisers against the effects of ageing and weathering, plasticizers, substances having fungistatic and bacteriostatic action, fillers (such as, for example, barium sulfate, kieselguhr, carbon black or precipitated chalk) and release agents.

These auxiliary substances and additives which are optionally to be used concomitantly are described, for example, in EP-A 0 000 389, pages 18-21. Further examples of auxiliary substances and additives which are optionally to be used concomitantly according to the invention as well as details of the manner of use and mode of action of such auxiliary substances and additives are described in Kunststoff-Handbuch, Volume VII, edited by G. Oertel, Carl-Hanser-Verlag, Munich, 3rd edition, 1993, for example on pages 104-127.

As catalysts there are preferably used aliphatic tertiary amines (for example trimethylamine, tetramethylbutanediamine), cycloaliphatic tertiary amines (for example 1,4-diaza(2,2,2)-bicyclooctane), aliphatic amino ethers (for example dimethylaminoethyl ether and N,N,N-trimethyl-N-hydroxyethyl-bisaminoethyl ether), cycloaliphatic amino ethers (for example N-ethylmorpholine), aliphatic amidines, cycloaliphatic amidines, urea, derivatives of urea (such as, for example, aminoalkylureas, see, for example, EP-A 0 176 013, in particular (3-dimethylaminopropylamine)-urea) and tin catalysts (such as, for example, dibutyltin oxide, dibutyltin dilaurate, tin octoate).

Particularly preferred catalysts are
α) urea, derivatives of urea and/or
β) amines and amino ethers each containing a functional group which reacts chemically with the isocyanate. The functional group is preferably a hydroxyl group, a primary or secondary amino group. These particularly preferred catalysts have the advantage that they have a greatly reduced migration and emission behaviour.

Examples of particularly preferred catalysts which may be mentioned are: (3-dimethylaminopropyl)-urea, 2-(2-dimethylaminoethoxy)ethanol, N,N-bis(3-dimethylaminopropyl)-N-isopropanolamine, N,N,N-trimethyl-N-hydroxyethyl-bisaminoethyl ether and 3-dimethylamino-propylamine.

### Component A5

The compounds according to component A5 are compounds having at least one semicarbazide group, that is to say the structural element shown in formula (I) below

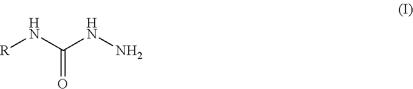

wherein R is an alkyl, alkylaryl or aryl radical, which can itself contain or be substituted by a semicarbazide group and/or other functional groups. Within the scope of the invention, other functional groups are to be understood as being, for example, a hydrazone group, an ester group, a urea group, a urethane group, an anhydride group. A substituted alkyl, alkylaryl or aryl radical within the scope of the invention is to be understood as meaning that the radical R can also contain heteroatoms such as, for example, halogen atoms, phosphorus atoms, sulfur atoms and can also be branched with alkyl or aryl groups.

An alkyl radical is preferably C₁- to C₃₀-alkyl, particularly preferably C₄- to C₁₆-alkyl, which can be linear or branched. An aryl radical is preferably phenyl, which can also be substituted by alkyl. An alkaryl radical contains alkyl and aryl radicals.

The compounds according to formulae (II) to (VIII) are given as preferred examples of compounds having at least one semicarbazide group (component A5).

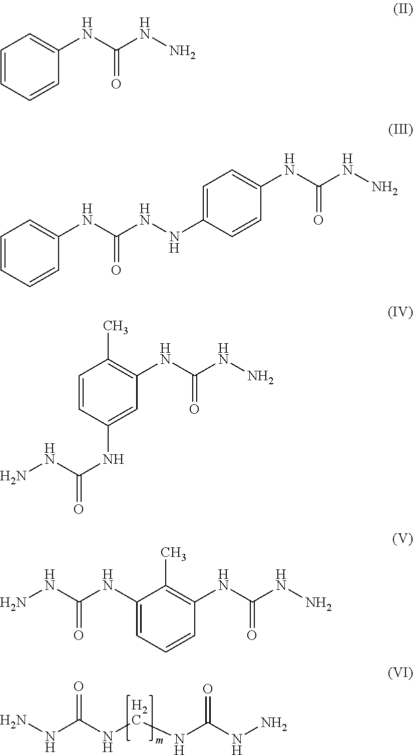

wherein in formula (VI) m is an integer from 1 to 16, preferably from 6 to 12, particularly preferably 6 or 12.

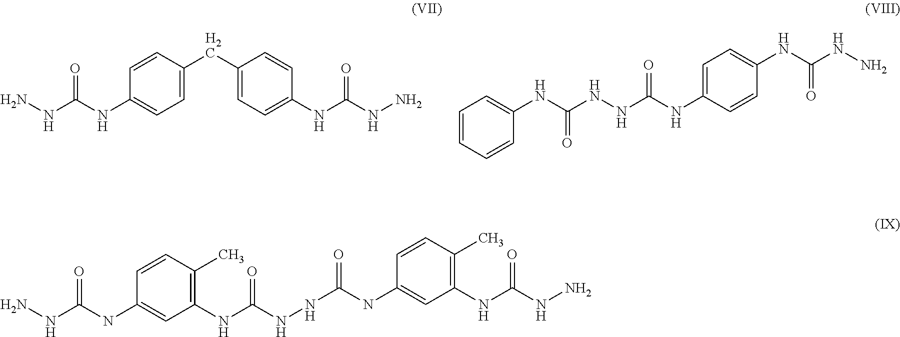

Within the scope of the invention, compounds having at least one semicarbazide group (component A5) are also to be understood as being compounds having an oligomeric or polymeric structure (“polyhydrazodicarbonamides”), as shown by way of example in formula (X)

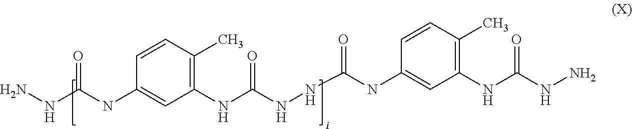

wherein in formula (X) i is an integer from 2 to 100,000, preferably from 1000 to 50,000, particularly preferably from 5000 to 25,000.

The compounds according to component A5 can be prepared, for example, by reaction of the underlying isocyanates with hydrazine according to the processes known to the person skilled in the art, as indicated by way of example in the experimental part of the present invention or in Mihail Ionescu: “Chemistry and Technology of Polyols for Polyurethanes”, Rapra Technology, Shawbury, Shrewsbury, Shropshire, 2005 on pages 215 to 219.

### Component B

As component B there are used aliphatic, cycloaliphatic, araliphatic, aromatic and heterocyclic polyisocyanates, as are described, for example, by W. Siefken in Justus Liebigs Annalen der Chemie, 562, pages 75 to 136, for example those of formula (V)

Q(NCO)ₙ (V)

in which
n=2-4, preferably 2-3,
   and
Q denotes an aliphatic hydrocarbon radical having from 2 to 18, preferably from 6 to 10, carbon atoms, a cycloaliphatic hydrocarbon radical having from 4 to 15, preferably from 6 to 13, carbon atoms, or an araliphatic hydrocarbon radical having from 8 to 15, preferably from 8 to 13, carbon atoms.

They are, for example, polyisocyanates as are described in EP-A 0 007 502, pages 7-8. Particular preference is generally given to the polyisocyanates which are readily obtainable industrially, for example 2,4- and 2,6-toluene diisocyanate as well as arbitrary mixtures of these isomers (“TDI”); polyphenylpolymethylene polyisocyanates, as are prepared by aniline-formaldehyde condensation and subsequent phosgenation (“crude MDI”), and polyisocyanates containing carbodiimide groups, urethane groups, allophanate groups, isocyanurate groups, urea groups or biuret groups (“modified polyisocyanates”), in particular those modified polyisocyanates which are derived from 2,4- and/or 2,6-toluene diisocyanate or from 4,4′- and/or 2,4′-diphenylmethane diisocyanate. There is preferably used as component B at least one compound selected from the group consisting of 2,4- and 2,6-toluene diisocyanate, 4,4′- and 2,4′- and 2,2′-diphenylmethane diisocyanate and polyphenylpolymethylene polyisocyanate (“polynuclear MDI”).

### Carrying Out the Process for the Production of Polyurethane Foams:

The reaction components are reacted by the one-shot process known per se, the prepolymer process or the semi-prepolymer process, use often being made of mechanical devices, for example those described in EP-A 355 000. Details of processing devices which are also suitable according to the invention are described in Kunststoff-Handbuch, Volume VII, edited by Vieweg and Höchtlen, Carl-Hanser-Verlag, Munich 1993, for example on pages 139 to 265.

The PUR foams can also be produced in the form of moulded or slabstock foams.

The moulded foams can be produced with hot or cold curing.

The invention therefore provides a process for the production of polyurethane foams, the polyurethane foams produced by that process and the use thereof in the production of mouldings, as well as the mouldings themselves.

The polyurethane foams obtainable according to the invention are used, for example, in the following applications: furniture upholstery, textile inserts, mattresses, automotive seats, headrests, armrests, sponges and structural elements, as well as seat and dashboard coverings.

### EXAMPLES

### Description of the Raw Materials

### Component A1-1:

Polyether polyol of OH number 28, prepared by addition of propylene oxide and ethylene oxide in a ratio of 86.2 to 13.8% using glycerol as starter with at least 80% primary OH groups.

### Component A1-2:

Polyether polyol of OH number 37, prepared by addition of ethylene oxide and propylene oxide in a ratio of 72.5% and 27.5% using glycerol as starter with at least 80% primary OH groups.

### Component A2-1: Diethanolamine

### Component A3-1: Water

### Component A4:

### Component A4-1:

Stabiliser Tegostab® B 8734 LF (Degussa-Goldschmidt).

### Component A4-2:

Activator Jeffcat® ZR 50 (Huntsman); an amine containing a functional group which reacts chemically with the isocyanate.

### Component A4-3:

Activator Dabco® Dabco NE 300 (Air Products); contains a urea derivative.

### Component A5-1:

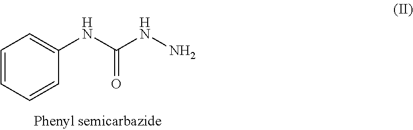

### Component A5-2:

Toluene-bis-semicarbazide, mixture of the 2,4-isomer (IV) and of the 2,6-isomer (V) in a ratio of 80:20.

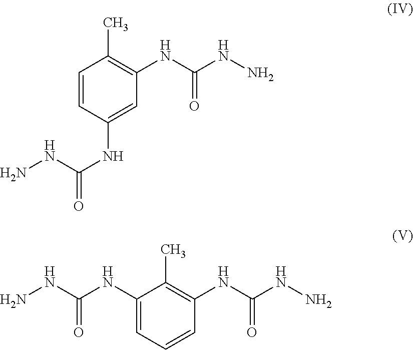

Preparation of component A5-2:

92.5 g of a mixture of 80% 2,4-toluene diisocyanate and 20% 2,6-toluene diisocyanate were added dropwise at room temperature (21° C.) to a solution of 100 g of a 35% aqueous hydrazine solution and 1000 ml of tetrahydrofuran. The resulting mixture was subsequently heated to 40° C. and maintained at 40° C. for 2 hours. Thereafter, the mixture was cooled to 10° C. and the supernatant phase, containing the organic solvent tetrahydrofuran, was decanted off. 500 ml of methanol were added to the aqueous phase that remained. At room temperature, this mixture was stirred for 15 hours, then the resulting finely crystalline precipitate was filtered off and then the resulting finely crystalline precipitate was dried in vacuo. 101 g of finely crystalline powder were obtained. OH number measured: 400 mg KOH/g

### Component A5-3:

Polyhydrazodicarbonamide, used in the form of a dispersion in a polyether polyol, the dispersion containing 20 wt. % polyhydrazodicarbonamide. The dispersion of the polyhydrazodicarbonamide was prepared by reaction of toluene diisocyanate (mixture of the 2,4-isomer and of the 2,6-isomer in a ratio of 80:20) with hydrazine in a polyether polyol.

### Component B-1

Isocyanate mixture (“MDI”) containing 57 wt. % 4,4′-diphenylmethane diisocyanate, 25 wt. % 2,4′-diphenylmethane diisocyanate and 18 wt. % polyphenylpolymethylene polyisocyanate (“polynuclear MDI”).

### Production of the Mouldings

Under the processing conditions of the raw material mixing conventional for the production of PUR foams, at room temperature, via a high-pressure mixing head, the starting components according to the recipe are introduced into a mould which has been heated to 60° C. and has a volume of 12.5 litres, and are removed from the mould after 4 minutes. The amount of raw materials used was so chosen that a calculated moulding density of 55 kg/m³ was obtained. The moulding density actually obtained, which was determined by weighing the compressive strength test specimen, is indicated in Table 1.

The index (isocyanate index) gives the percentage ratio of the amount of isocyanate actually used to the stoichiometric, i.e. calculated, amount of isocyanate groups (NCO):

Index=[(amount of isocyanate used):(amount of isocyanate calculated)]·100 (VI)

The compressive strength was determined according to DIN EN ISO 3386-1-98.

The compression set CS 50% and CS 75% was determined according to DIN EN ISO 1856-2001-03 at 50% and 75% deformation, respectively.

The formaldehyde content was determined in accordance with BMW method AA-C291 but, in a departure from that method, (a) angular glass bottles were used instead of round polyethylene bottles, (b) the test specimen used had a thickness of 1 cm (instead of 4 mm), (c) a calibration standard of Cerilliant was used, and (d) the moisture content of the sample was not determined.

The compression set at 70% deformation after storage under warm, humid conditions (WHS), i.e. 22 hours at 40° C. and 95% rel. humidity (CS 70% after WHS) was determined according to DIN EN ISO 1856-2001-03.

### Results

The formaldehyde value determined according to the BMW test for determining the emission of aldehydes from polymeric materials and mouldings by means of HPLC PA-C325 is reduced to 0.3 ppm by the compound according to the invention of Example 2 (4-phenyl semicarbazide), while the comparison in Example 1 exhibits a formaldehyde content of 2.4 ppm. Examples 3 to 5 according to the invention show that the compounds of components A5-2 and A5-3 surprisingly also reduce the formaldehyde value determined by means of HPLC PA-C325.

TABLE 1
Compositions and properties of the resulting mouldings

| Components | 1 | | | | |
|---|---|---|---|---|---|
| [parts by weight] | (comparison) | 2 | 3 | 4 | 5 |
| A. Polyol formulation | | | | | |
| A1-1 | 97.0 | 97.0 | 97.0 | 87.0 | 47.0 |
| A1-2 | 3.0 | 3.0 | 3.0 | 3.0 | 3.0 |
| A2-1 (diethanolamine) | 1.0 | 1.0 | 10 | 1.0 | 1.0 |
| A3-1 (water) | 3.2 | 3.2 | 3.2 | 3.2 | 3.2 |
| A4-1 | 0.9 | 0.9 | 0.9 | 0.9 | 0.9 |
| A4-2 | 0.4 | 0.4 | 0.4 | 0.4 | 0.4 |
| A4-3 | 0.1 | 0.1 | 0.1 | 0.1 | 0.1 |
| A5-1 | — | 2.0 | — | — | — |
| A5-2 | — | — | 5.0 | | |
| A5-3 ¹⁾ | — | — | | 10.0 | 50.0 |
| B. Isocyanate | | | | | |
| B-1 based on 100 parts by | 53.1 | 52.12 | 50.7 | 53.1 | 53.1 |
| weight of polyol | | | | | |
| formulation [parts by | | | | | |
| weight] | | | | | |
| Index | 95 | 95 | 95 | 95 | 95 |
| Properties | | | | | |
| Apparent density [kg/m³] | 55.0 | 55.0 | 53 | 56 | 55 |
| Formaldehyde content | 2.4 | 0.3 | 0.8 | 0.4 | 0.1 |
| according to BMW test | | | | | |
| according to PA-C325 | | | | | |
| [ppm] | | | | | |
| Compressive strength | 6.0 | 6.3 | 5.2. | 6.8 | 8.1. |
| [kPa] | | | | | |
| CS 50% [%] | 6.4 | 5.6 | 9.2. | 5.4 | 5.6 |
| CS 75% [%] | 8.6 | 8.0 | 12.4 | 7.4 | 8.3 |
| CS 70% after WHS [%] | 15.3 | 14.3 | 19.0 | 15.1 | 15.6 |

n.m. = not measured
¹⁾ The amount (parts by weight) of the dispersion used, which contained 20 wt. % polyhydrazocarbonamide, is indicated. Accordingly, the amount of polyhydrazodicarbonamide effectively used in the polyol formulation according to Example 4 was 2.0 parts by weight and in Example 5 was 10.0 parts by weight.

1-7. (canceled)

8. A process for producing polyurethane foams with reduced formaldehyde emission comprising reacting
A1 compounds containing isocyanate-reactive hydrogen atoms and having a molecular weight of from 400 to 15,000,
A2 optionally compounds containing isocyanate-reactive hydrogen atoms and having a molecular weight of from 62 to 399,
A3 water and/or physical foaming agents,
A4 optionally auxiliary substances and additives,
A5 compounds having at least one semicarbazide group
with
B di- or poly-isocyanates.

9. The process of claim 8, wherein the amount of component A5 that is used, based on 100 parts by weight of components A1 to A4, is from 0.1 to 10 parts by weight.

10. The process of claim 8, wherein
A1 is from 75 to 99.5 parts by weight (based on the sum of the parts by weight of components A1 to A4) of compounds containing isocyanate-reactive hydrogen atoms and having a molecular weight of from 400 to 15,000,
A2 is from 0 to 10 parts by weight (based on the sum of the parts by weight of components A1 to A4) of compounds containing isocyanate-reactive hydrogen atoms and having a molecular weight of from 62 to 399,
A3 is from 0.5 to 25 parts by weight (based on the sum of the parts by weight of components A1 to A4) of water and/or physical foaming agents,
A4 is from 0 to 10 parts by weight (based on the sum of the parts by weight of components A1 to A4) of auxiliary substances and additives,
A5 is from 0.1 to 10 parts by weight (based on the sum of the parts by weight of components A1 to A4) of compounds having at least one semicarbazide group, and
wherein the production is carried out at an index of from 50 to 250.

11. The process of claim 8, wherein A4 comprises
a) catalysts,
b) surface-active additives (surfactants), and
c) additives such as reaction retardants, cell regulators, pigments, colorings, flame retardants, stabilisers against the effects of ageing and weathering, plasticizers, substances having fungistatic and bacteriostatic action, fillers and release agents.

12. The process of claim 8, wherein there are used as catalysts
a) urea, the above-mentioned derivatives of urea and/or
b) as well as aliphatic tertiary amines, cycloaliphatic tertiary amines, aliphatic amino ethers, cycloaliphatic amino ethers, characterised in that the amines and amino ethers contain a functional group which reacts chemically with the isocyanate.

13. Use of compounds having at least one semicarbazide group (component A5) in polyurethane compositions or in processes for the production of polyurethane foams for reducing the formaldehyde emission.

14. The process of claim 8, wherein there are used as compounds having at least one semicarbazide group (component A5) at least one of the compounds according to formulae (II) to (X): 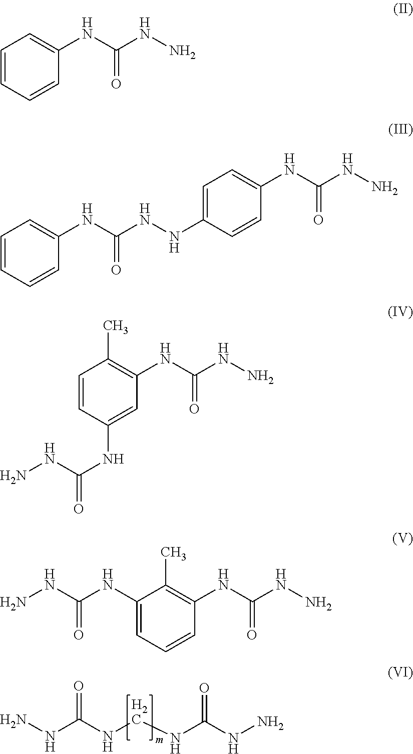
wherein in formula (VI) m denotes an integer from 1 to 16, 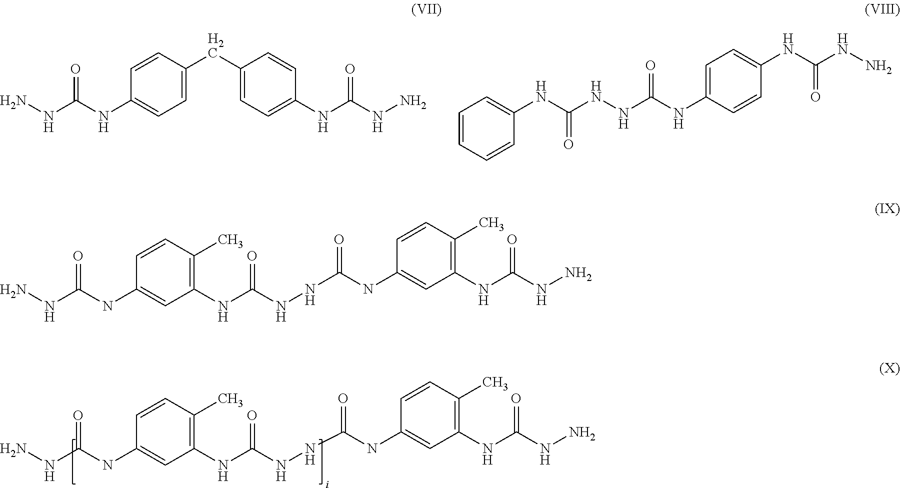
wherein in formula (X) i denotes an integer from 2 to 100,000.
